(19) United States
(12) Patent Application Publication
(10) Pub. No.: US 2006/0293860 A1
(43) Pub. Date: Dec. 28, 2006

(54) SYSTEM, METHOD, AND COMPUTER PRODUCT FOR CORRECTION OF FEATURE OVERLAP

(75) Inventors: Vincent E. Bressler, Menlo Park, CA (US); Albert K. Bukys, Lexington, MA (US); David Stern, Mountain View, CA (US)

Correspondence Address: AFFYMETRIX, INC;ATTN: CHIEF IP COUNSEL, LEGAL DEPT., 3420 CENTRAL EXPRESSWAY, SANTA CLARA, CA, 95051, US

(73) Assignee: Affymetrix, Inc., a Corporation Organized under the Laws of Delaware

(21) Appl. No.: 11/427,103

(22) Filed: Jun. 28, 2006

Related U.S. Application Data
(60) Provisional application No. 60/694,719, filed on Jun. 28, 2005.

(51) Int. Cl. G06F 19/00

(52) U.S. Cl. 702/20

(57) ABSTRACT

In one embodiment, a method for correcting feature overlap in biological probe array data is described that comprises (a) receiving a first set of data comprising an intensity value for each of a plurality of features associated with a probe array; (b) calculating a crosstalk parameter for the first set of data using the intensity values of one or more test features and a plurality of features that neighbor each test feature; and (c) applying the crosstalk parameter to each intensity value in the first set of data to produce a second set of data.

### RELATED APPLICATIONS

The present application claims priority from U.S. Provisional Patent Application Ser. No. 60/694,719, titled “System, Method, and Computer Product for Correction of Feature Overlap”, filed Jun. 28, 2005, which is hereby incorporated by reference herein in its entirety for all purposes.

### BACKGROUND

Field of the Invention.

The present invention relates to systems and methods for examining biological material. In particular, the invention relates to a system and method for improving the quality of data from scanned biological probe arrays. The limited spatial resolution of optical systems may cause blurring of features. Consequently, some features in the image contribute some degree of signal to one or more of their neighboring features. This is particularly evident in the case where bright features contribute signal to neighboring dim features. The amount of crosstalk between features depends upon the point spread function of the instrument. For example, crosstalk between neighboring features can be measured and removed mathematically, resulting in more accurate determination of feature intensities.

Related Art.

Synthesized nucleic acid probe arrays, such as Affymetrix GeneChip® probe arrays, and spotted probe arrays, have been used to generate unprecedented amounts of information about biological systems. For example, the GeneChip® Human Genome U133 Pus 2.0 Array available from Affymetrix, Inc. of Santa Clara, Calif., is comprised of one microarray containing 1,300,000 oligonucleotide features covering more than 47,000 transcripts and variants that include 38,500 well characterized human genes. Other examples of GeneChip® arrays are targeted to provide data aimed at different areas of specialization. Examples of specialized uses include analysis of Single Nucleotide Polymorphisms (SNPs) provided by the GeneChip® Human Mapping 10K, 100K, or 500K Arrays, or analysis of alternative splicing events provided by the GeneChip® Human Exon 1.0 ST Array. Analysis of data from such microarrays may lead to the development of new drugs and new diagnostic tools.

### SUMMARY OF THE INVENTION

Systems, methods, and products to address these and other needs are described herein with respect to illustrative, non-limiting, implementations. Various alternatives, modifications and equivalents are possible. For example, certain systems, methods, and computer software products are described herein using exemplary implementations for analyzing data from arrays of biological materials, in particular in relation to data from Affymetrix® GeneChip® probe arrays. However, these systems, methods, and products may be applied with respect to many other types of probe arrays and, more generally, with respect to numerous parallel biological assays produced in accordance with other conventional technologies and/or produced in accordance with techniques that may be developed in the future. For example, the systems, methods, and products described herein may be applied to parallel assays of nucleic acids, PCR products generated from cDNA clones, proteins, antibodies, or many other biological materials. These materials may be disposed on slides (as typically used for spotted arrays), on substrates employed for GeneChip® arrays, or on beads, optical fibers, or other substrates or media, which may include polymeric coatings or other layers on top of slides or other substrates. Moreover, the probes need not be immobilized in or on a substrate, and, if immobilized, need not be disposed in regular patterns or arrays. For convenience, the term “probe array” will generally be used broadly hereafter to refer to all of these types of arrays and parallel biological assays.

In one embodiment, a method for correcting feature overlap in biological probe array data is described that comprises (a) receiving a first set of data comprising an intensity value for each of a plurality of features associated with a probe array; (b) calculating a crosstalk parameter for the first set of data using the intensity values of one or more test features and a plurality of features that neighbor each test feature; and (c) applying the crosstalk parameter to each intensity value in the first set of data to produce a second set of data.

Also, a system for correcting feature overlap in biological probe array data is described that comprises an input manager that receives a first set of data comprising an intensity value for each of a plurality of features associated with a probe array; a calculator that calculates a crosstalk parameter for the first set of data using the intensity values of one or more test features and a plurality of features that neighbor each test feature; and an adjuster that applies the crosstalk parameter to each intensity value in the first set of data to produce a second set of data.

Further, a system for correcting feature overlap in biological probe array data is described that comprises a scanner that acquires a first set of data from a biological probe array; and a computer comprising executable code stored thereon, wherein the executable code performs a method of: processing the first set of data to produce a second set of data comprising an intensity value for each of a plurality of features associated with the probe array; calculating a crosstalk parameter for the second set of data using the intensity values of one or more test features and one or more features that neighbor each test feature; and applying the crosstalk parameter to each intensity value in the second set of data to produce a third set of data.

The above embodiments and implementations are not necessarily inclusive or exclusive of each other and may be combined in any manner that is non-conflicting and otherwise possible, whether they be presented in association with a same, or a different, embodiment or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above embodiment and implementations are illustrative rather than limiting.

### BRIEF DESCRIPTION OF THE DRAWINGS

The above and further features will be more clearly appreciated from the following detailed description when taken in conjunction with the accompanying drawings. In the drawings, like reference numerals indicate like structures or method steps and the leftmost digit of a reference numeral indicates the number of the figure in which the referenced element first appears (for example, the element 160 appears first in FIG. 1). In functional block diagrams, rectangles generally indicate functional elements and parallelograms generally indicate data. In method flow charts, rectangles generally indicate method steps and diamond shapes generally indicate decision elements. All of these conventions, however, are intended to be typical or illustrative, rather than limiting.

FIG. 1 is a functional block diagram of one embodiment of a computer and a server enabled to communicate over a network, as well as a probe array and probe array instruments;

FIG. 2 is a functional block diagram of one embodiment of the computer system of FIG. 1, including a display device that presents a graphical user interface to a user;

FIG. 3 is a functional block diagram of one embodiment of the server of FIG. 1, where the server comprises an executable version of an instrument control and image processing application and an analysis application;

FIG. 4 is a functional block diagram of the analysis application of FIG. 3 comprising elements for determining and correcting feature leakage; and

FIG. 5 is a functional block diagram of a method for determining and correcting feature leakage.

### DETAILED DESCRIPTION

a) General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including but not limited to mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, New York, Gait, “Oligonucleotide Synthesis: A Practical Approach” 1984, IRL Press, London, Nelson and Cox (2000), Lehninger, Principles of Biochemistry 3^{rd} Ed., W. H. Freeman Pub., New York, N.Y. and Berg et al. (2002) Biochemistry, 5^{th} Ed., W. H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,945,334, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication Number WO 99/36760) and PCT/US01/04285 (International Publication Number WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip® arrays are shown on the website at affymetrix.com.

The present invention also contemplates many uses for polymers attached to solid substrates. These uses include gene expression monitoring, profiling, library screening, genotyping and diagnostics. Gene expression monitoring and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 10/442,021, 10/013,598 (U.S. Patent Application Publication 20030036069), and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, e.g., PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Patent Nos. 4,683,202, 4,683,195, 4,800,159 4,965,188,and 5,333,675, and each of which is incorporated herein by reference in their entireties for all purposes. The sample may be amplified on the array. See, for example, U.S. Pat. No. 6,300,070 and U.S. Ser. No. 09/513,300, which are incorporated herein by reference. Other suitable amplification methods include the ligase chain reaction (LCR) (e.g., Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No 6,410,276), consensus sequence primed polymerase chain reaction (CP-PCR) (U.S. Pat. No. 4,437,975), arbitrarily primed polymerase chain reaction (AP-PCR) (U.S. Pat. No. 5,413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. No. 6,361,947, 6,391,592 and U.S. Ser. Nos. 09/916,135, 09/920,491 (U.S. Patent Application Publication 20030096235), 09/910,292 (U.S. Patent Application Publication 20030082543), and 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2^{nd} Ed. Cold Spring Harbor, N.Y., 1989); Berger and Kimmel Methods in Enzymology, Vol. 152, Guide to Molecular Cloning Techniques (Academic Press, Inc., San Diego, Calif, 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference

The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. Ser. No. 10/389,194 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Ser. Nos. 10/389,194, 10/913,102, 10/846,261, 11/260,617 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, e.g. Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2^{nd}., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/197,621, 10/063,559 (U.S. Publication No. 20020183936), 10/065,856, 10/065,868, 10/328,818, 10/328,872, 10/423,403, and 60/482,389.

b) Definitions

The term “array” as used herein refers to an intentionally created collection of molecules which can be prepared either synthetically or biosynthetically. The molecules in the array can be identical or different from each other. The array can assume a variety of formats, e.g., libraries of soluble molecules; libraries of compounds tethered to resin beads, silica chips, or other solid supports.

The term “biomonomer” as used herein refers to a single unit of biopolymer, which can be linked with the same or other biomonomers to form a biopolymer (for example, a single amino acid or nucleotide with two linking groups one or both of which may have removable protecting groups) or a single unit which is not part of a biopolymer. Thus, for example, a nucleotide is a biomonomer within an oligonucleotide biopolymer, and an amino acid is a biomonomer within a protein or peptide biopolymer; avidin, biotin, antibodies, antibody fragments, etc., for example, are also biomonomers.

The term “biopolymer” or “biological polymer” as used herein is intended to mean repeating units of biological or chemical moieties. Representative biopolymers include, but are not limited to, nucleic acids, oligonucleotides, amino acids, proteins, peptides, hormones, oligosaccharides, lipids, glycolipids, lipopolysaccharides, phospholipids, synthetic analogues of the foregoing, including, but not limited to, inverted nucleotides, peptide nucleic acids, Meta-DNA, and combinations of the above.

The term “biopolymer synthesis” as used herein is intended to encompass the synthetic production, both organic and inorganic, of a biopolymer. Related to a bioploymer is a “biomonomer”.

The term “complementary” as used herein refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are said to be complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

The term “combinatorial synthesis strategy” as used herein refers to a combinatorial synthesis strategy is an ordered strategy for parallel synthesis of diverse polymer sequences by sequential addition of reagents which may be represented by a reactant matrix and a switch matrix, the product of which is a product matrix. A reactant matrix is a 1 column by m row matrix of the building blocks to be added. The switch matrix is all or a subset of the binary numbers, preferably ordered, between 1 and m arranged in columns. A “binary strategy” is one in which at least two successive steps illuminate a portion, often half, of a region of interest on the substrate. In a binary synthesis strategy, all possible compounds which can be formed from an ordered set of reactants are formed. In most preferred embodiments, binary synthesis refers to a synthesis strategy which also factors a previous addition step. For example, a strategy in which a switch matrix for a masking strategy halves regions that were previously illuminated, illuminating about half of the previously illuminated region and protecting the remaining half (while also protecting about half of previously protected regions and illuminating about half of previously protected regions). It will be recognized that binary rounds may be interspersed with non-binary rounds and that only a portion of a substrate may be subjected to a binary scheme. A combinatorial “masking” strategy is a synthesis which uses light or other spatially selective deprotecting or activating agents to remove protecting groups from materials for addition of other materials such as amino acids.

The term “complex population or mixed population” as used herein refers to any sample containing both desired and undesired nucleic acids. As a non-limiting example, a complex population of nucleic acids may be total genomic DNA, total genomic RNA or a combination thereof. Moreover, a complex population of nucleic acids may have been enriched for a given population but include other undesirable populations. For example, a complex population of nucleic acids may be a sample which has been enriched for desired messenger RNA (mRNA) sequences but still includes some undesired ribosomal RNA sequences (rRNA).

The term “effective amount” as used herein refers to an amount sufficient to induce a desired result.

The term “genome” as used herein is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

The term “hybridization conditions” as used herein will typically include salt concentrations of less than about 1M, more usually less than about 500 mM and preferably less than about 200 mM. Hybridization temperatures can be as low as 5.degree. C., but are typically greater than 22.degree. C., more typically greater than about 30.degree. C., and preferably in excess of about 37.degree. C. Longer fragments may require higher hybridization temperatures for specific hybridization. As other factors may affect the stringency of hybridization, including base composition and length of the complementary strands, presence of organic solvents and extent of base mismatching, the combination of parameters is more important than the absolute measure of any one alone.

The term “hybridization” as used herein refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.” Hybridizations are usually performed under stringent conditions, for example, at a salt concentration of no more than 1 M and a temperature of at least 25° C. For example, conditions of 5× SSPE (750 mM NaCl, 50 mM NaPhosphate, 5 mM EDTA, pH 7.4) and a temperature of 25-30° C. are suitable for allele-specific probe hybridizations. For stringent conditions, see, for example, Sambrook, Fritsche and Maniatis. “Molecular Cloning A laboratory Manual” 2^{nd} Ed. Cold Spring Harbor Press (1989) which is hereby incorporated by reference in its entirety for all purposes above.

Hybridizations, e.g., allele-specific probe hybridizations, are generally performed under stringent conditions. For example, conditions where the salt concentration is no more than about 1 Molar (M) and a temperature of at least 25 degrees-Celsius (° C.), e.g., 750 mM NaCl, 50 mM NaPhosphate, 5 mM EDTA, pH 7.4 (5× SSPE)and a temperature of from about 25 to about 30° C.

The term “hybridization probes” as used herein are oligonucleotides capable of binding in a base-specific manner to a complementary strand of nucleic acid. Such probes include peptide nucleic acids, as described in Nielsen et al., Science 254, 1497-1500 (1991), and other nucleic acid analogs and nucleic acid mimetics.

The term “hybridizing specifically to” as used herein refers to the binding, duplexing, or hybridizing of a molecule only to a particular nucleotide sequence or sequences under stringent conditions when that sequence is present in a complex mixture (e.g., total cellular) DNA or RNA.

The term “initiation biomonomer” or “initiator biomonomer” as used herein is meant to indicate the first biomonomer which is covalently attached via reactive nucleophiles to the surface of the polymer, or the first biomonomer which is attached to a linker or spacer arm attached to the polymer, the linker or spacer arm being attached to the polymer via reactive nucleophiles.

The term “isolated nucleic acid” as used herein mean an object species invention that is the predominant species present (i.e., on a molar basis it is more abundant than any other individual species in the composition). Preferably, an isolated nucleic acid comprises at least about 50, 80 or 90% (on a molar basis) of all macromolecular species present. Most preferably, the object species is purified to essential homogeneity (contaminant species cannot be detected in the composition by conventional detection methods).

The term “ligand” as used herein refers to a molecule that is recognized by a particular receptor. The agent bound by or reacting with a receptor is called a “ligand,” a term which is definitionally meaningful only in terms of its counterpart receptor. The term “ligand” does not imply any particular molecular size or other structural or compositional feature other than that the substance in question is capable of binding or otherwise interacting with the receptor. Also, a ligand may serve either as the natural ligand to which the receptor binds, or as a functional analogue that may act as an agonist or antagonist. Examples of ligands that can be investigated by this invention include, but are not restricted to, agonists and antagonists for cell membrane receptors, toxins and venoms, viral epitopes, hormones (e.g., opiates, steroids, etc.), hormone receptors, peptides, enzymes, enzyme substrates, substrate analogs, transition state analogs, cofactors, drugs, proteins, and antibodies.

The term “linkage disequilibrium or allelic association” as used herein refers to the preferential association of a particular allele or genetic marker with a specific allele, or genetic marker at a nearby chromosomal location more frequently than expected by chance for any particular allele frequency in the population. For example, if locus X has alleles a and b, which occur equally frequently, and linked locus Y has alleles c and d, which occur equally frequently, one would expect the combination ac to occur with a frequency of 0.25. If ac occurs more frequently, then alleles a and c are in linkage disequilibrium. Linkage disequilibrium may result from natural selection of certain combination of alleles or because an allele has been introduced into a population too recently to have reached equilibrium with linked alleles.

The term “mixed population” as used herein refers to a complex population.

The term “monomer” as used herein refers to any member of the set of molecules that can be joined together to form an oligomer or polymer. The set of monomers useful in the present invention includes, but is not restricted to, for the example of (poly)peptide synthesis, the set of L-amino acids, D-amino acids, or synthetic amino acids. As used herein, “monomer” refers to any member of a basis set for synthesis of an oligomer. For example, dimers of L-amino acids form a basis set of 400 “monomers” for synthesis of polypeptides. Different basis sets of monomers may be used at successive steps in the synthesis of a polymer. The term “monomer” also refers to a chemical subunit that can be combined with a different chemical subunit to form a compound larger than either subunit alone.

The term “mRNA” or “mRNA transcripts” as used herein, include, but not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, an RNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like.

The term “nucleic acid library or array” as used herein refers to an intentionally created collection of nucleic acids which can be prepared either synthetically or biosynthetically and screened for biological activity in a variety of different formats (e.g., libraries of soluble molecules; and libraries of oligos tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

The term “nucleic acids” as used herein may include any polymer or oligomer of pyrimidine and purine bases, preferably cytosine, thymine, and uracil, and adenine and guanine, respectively. See Albert L. Lehninger, PRINCIPLES OF BIOCHEMISTRY, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

The term “oligonucleotide” or “polynucleotide” as used herein refers to a nucleic acid ranging from at least 2, preferable at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

The term “probe” as used herein refers to a surface-immobilized molecule that can be recognized by a particular target. See U.S. Pat. No. 6,582,908 for an example of arrays having all possible combinations of probes with 10, 12, and more bases. Examples of probes that can be investigated by this invention include, but are not restricted to, agonists and antagonists for cell membrane receptors, toxins and venoms, viral epitopes, hormones (e.g., opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

The term “primer” as used herein refers to a single-stranded oligonucleotide capable of acting as a point of initiation for template-directed DNA synthesis under suitable conditions e.g., buffer and temperature, in the presence of four different nucleoside triphosphates and an agent for polymerization, such as, for example, DNA or RNA polymerase or reverse transcriptase. The length of the primer, in any given case, depends on, for example, the intended use of the primer, and generally ranges from 15 to 30 nucleotides. Short primer molecules generally require cooler temperatures to form sufficiently stable hybrid complexes with the template. A primer need not reflect the exact sequence of the template but must be sufficiently complementary to hybridize with such template. The primer site is the area of the template to which a primer hybridizes. The primer pair is a set of primers including a 5′ upstream primer that hybridizes with the 5′ end of the sequence to be amplified and a 3′ downstream primer that hybridizes with the complement of the 3′ end of the sequence to be amplified.

The term “polymorphism” as used herein refers to the occurrence of two or more genetically determined alternative sequences or alleles in a population. A polymorphic marker or site is the locus at which divergence occurs. Preferred markers have at least two alleles, each occurring at frequency of greater than 1%, and more preferably greater than 10% or 20% of a selected population. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. Single nucleotide polymorphisms (SNPs) are included in polymorphisms.

The term “receptor” as used herein refers to a molecule that has an affinity for a given ligand.

Receptors may be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, monoclonal antibodies and antisera reactive with specific antigenic determinants (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands. As the term receptors is used herein, no difference in meaning is intended. A “Ligand Receptor Pair” is formed when two macromolecules have combined through molecular recognition to form a complex. Other examples of receptors which can be investigated by this invention include but are not restricted to those molecules shown in U.S. Pat. No. 5,143,854, which is hereby incorporated by reference in its entirety.

The term “solid support”, “support”, and “substrate” as used herein are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

The term “target” as used herein refers to a molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term targets is used herein, no difference in meaning is intended. A “Probe Target Pair” is formed when two macromolecules have combined through molecular recognition to form a complex.

c) Embodiments of the Present Invention

Embodiments of an analysis system, methods, and computer software application are described that measure and correct what is referred to as “feature leakage” or “crosstalk” in images generated by scanning biological probe arrays. The term crosstalk as used herein generally refers to the contribution of signal from a feature to one or more of its neighboring features in an image. In particular, embodiments for feature intensity correction are described that measure and correct for crosstalk in probe array data files comprising a single intensity value for each probe feature. A crosstalk parameter value is determined and applied to the intensity values in the data file to remove to effects of crosstalk. The result is a set of intensity data with improved data quality that is more representative of the true state.

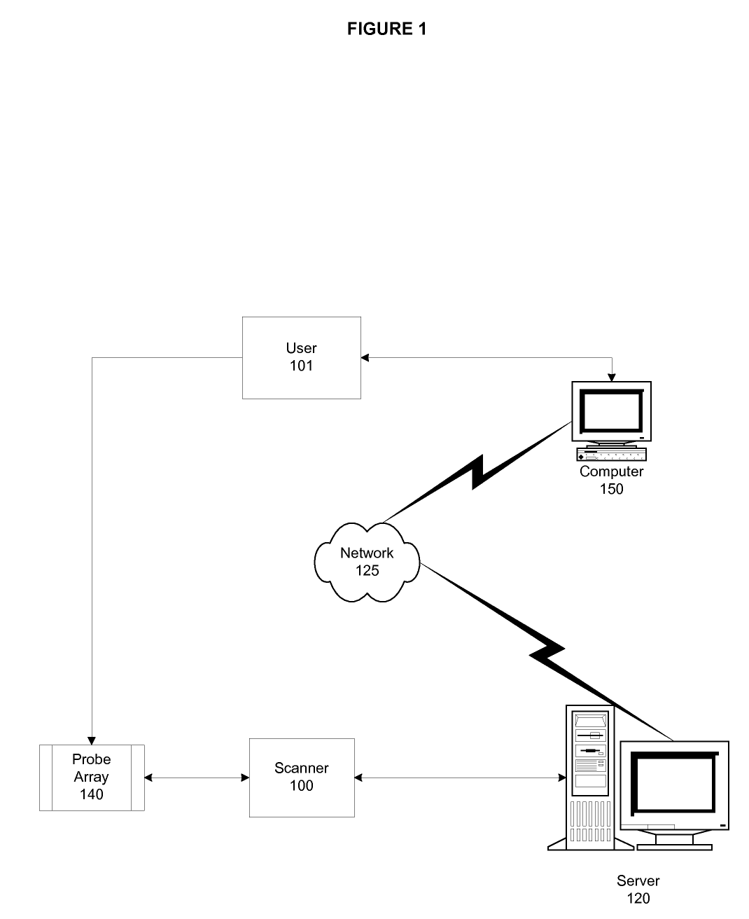

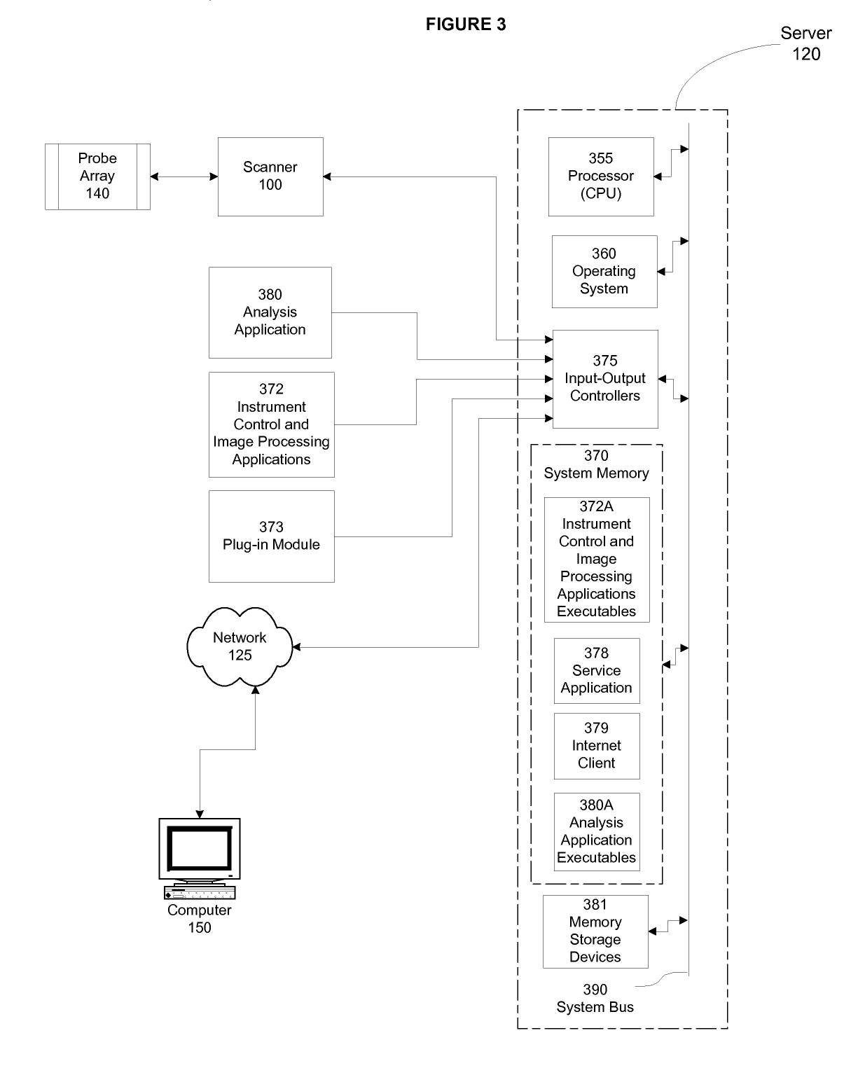

Probe Array 140: An illustrative example of probe array 140 is provided in FIGS. 1, and 3. Descriptions of probe arrays are provided above with respect to “Nucleic Acid Probe arrays” and other related disclosure. In various implementations, probe array 140 may be disposed in a cartridge or housing such as, for example, the GeneChip® probe array available from Affymetrix, Inc. of Santa Clara Calif. Examples of probe arrays and associated cartridges or housings may be found in U.S. Pat. Serial Nos. 5,945,334, 6,287,850, 6,399,365, 6,551,817, each of which is also hereby incorporated by reference herein in its entirety for all purposes. In addition, some embodiments of probe array 140 may be associated with pegs or posts. For instance probe array 140 may be affixed to a peg or post via gluing, welding, or other means known in the related art. Also the peg or post may be operatively coupled to a tray, strip, or other type of similar structure, where probe array 140 is extended away from the tray, strip, or structure by a distance measured by the height of the peg or post. Examples with embodiments of probe array 140 associated with pegs or posts may be found in U.S. Pat. Serial No. 10/826,577, titled “Immersion Array Plates for Interchangeable Microtiter Well Plates”, filed Apr. 16, 2004, which is hereby incorporated by reference herein in its entirety for all purposes.

Scanner 100: Labeled targets hybridized to probe arrays may be detected using various devices, sometimes referred to as scanners, as described above with respect to methods and apparatus for signal detection. An illustrative device is shown in FIG. 1 as scanner 100. For example, some embodiments of scanners image targets by detecting fluorescent or other emissions from labels associated with target molecules, or by detecting transmitted, reflected, or scattered radiation. A typical scheme employs optical and other elements to provide excitation light and to selectively collect the emissions.

For example, scanner 100 provides a signal representing the intensities (and possibly other characteristics, such as color that may be associated with a detected wavelength) of the detected emissions or reflected wavelengths of light, as well as the locations on the substrate where the emissions or reflected wavelengths were detected. Typically, the signal includes intensity information corresponding to elemental sub-areas of the scanned substrate. The term “elemental” in this context means that the intensities, and/or other characteristics, of the emissions or reflected wavelengths from this area each are represented by a single value. When displayed as an image for viewing or processing, elemental picture elements, or pixels, often represent this information. Thus, in the present example, a pixel may have a single value representing the intensity of the elemental sub-area of the substrate from which the emissions or reflected wavelengths were scanned. The pixel may also have another value representing another characteristic, such as color, positive or negative image, or other type of image representation. The size of a pixel may vary in different embodiments and could include a 2.5 μm, 1.5 μm, 1.0 μm, or sub-micron pixel size. Examples where the signal may be incorporated into data files may include incorporating data according to the well known *.dat or *.tif file formats as generated respectively by instrument control and image processing applications 372 (described in greater detail below).

Embodiments of scanner 100 may include various elements and/or optical architectures enabled for fluorescent detection. For instance, some embodiments of scanner 100 may employ what is referred to as a “confocal” type architecture that may include the use of photomultiplier tubes to as detection elements. Alternatively, some embodiments of scanner 100 may employ a CCD type (referred to as a Charge Coupled Device) architecture using what is referred to as a CCD or cooled CCD cameras as detection elements. Further examples of scanner systems that may be implemented with embodiments of the present invention include U.S. patent application Ser. No. 10/389,194, 10/846,261, 10/913,102, and 11/260,617; each of which are incorporated by reference above; and U.S. patent application Ser. No. 11/379,641, titled “Methods and Devices for Reading Microarrays”, filed Apr. 21, 2006, which is hereby incorporated by reference herein in its entirety for all purposes.

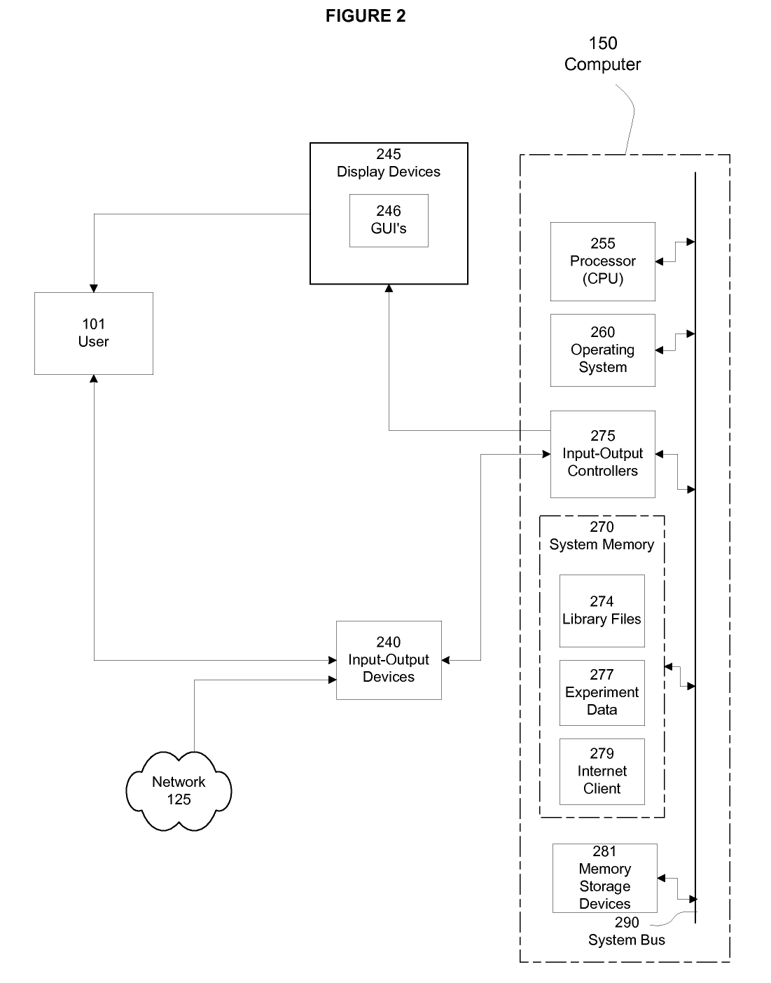

Computer 150: An illustrative example of computer 150 is provided in FIG. 1 and also in greater detail in FIG. 2. Computer 150 may be any type of computer platform such as a workstation, a personal computer, a server, or any other present or future computer. Computer 150 typically includes known components such as a processor 255, an operating system 260, system memory 270, memory storage devices 281, and input-output controllers 275, input-output devices 240, and display devices 245. Display devices 245 may include display devices that provides visual information, this information typically may be logically and/or physically organized as an array of pixels. An interface controller may also be included that may comprise any of a variety of known or future software programs for providing input and output interfaces such as for instance interfaces 246. For example, interfaces 246 may include what are generally referred to as “Graphical User Interfaces” (often referred to as GUI's) that provide one or more graphical representations to a user, such as user 101. Interfaces 246 are typically enabled to accept user inputs using means of selection or input known to those of ordinary skill in the related art.

In the same or alternative embodiments, applications on computer 150 may employ interface 246 that include what are referred to as “command line interfaces” (often referred to as CLI's). CLI's typically provide a text based interaction between the application and user 101. Typically, command line interfaces present output and receive input as lines of text through display devices 245. For example, some implementations may include what are referred to as a “shell” such as Unix Shells known to those of ordinary skill in the related art, or Microsoft Windows Powershell that employs object-oriented type programming architectures such as the Microsoft.NET framework.

Those of ordinary skill in the related art will appreciate that interfaces 246 may include one or more GUI's, CLI's or a combination thereof.

It will be understood by those of ordinary skill in the relevant art that there are many possible configurations of the components of computer 150 and that some components that may typically be included in computer 150 are not shown, such as cache memory, a data backup unit, and many other devices. Processor 255 may be a commercially available processor such as an Itanium® or Pentium® processor made by Intel Corporation, a SPARC® processor made by Sun Microsystems, an Athalon® or Opteron processor made by AMD corporation, or it may be one of other processors that are or will become available. Some embodiments of processor 255 may also include what are referred to as Multi-core processors and/or be enabled to employ parallel processing technology in a single or multi-core configuration. For example, a multi-core architecture typically comprises two or more processor “execution cores”. In the present example each execution core may perform as an independent processor that enables parallel execution of multiple threads. In addition, those of ordinary skill in the related will appreciate that processor 255 may be configured in what is generally referred to as 32 or 64 bit architectures, or other architectural configurations now known or that may be developed in the future.

Processor 255 executes operating system 260, which may be, for example, a Windows® type operating system (such as Windows® XP) from the Microsoft Corporation; the Mac OS X operating system from Apple Computer Corp. (such as 7.5 Mac OS X v10.4 “Tiger” or 7.6 Mac OS X v10.5 “Leopard” operating systems); a Unix® or Linux-type operating system available from many vendors or what is referred to as an open source; another or a future operating system; or some combination thereof. Operating system 260 interfaces with firmware and hardware in a well-known manner, and facilitates processor 255 in coordinating and executing the functions of various computer programs that may be written in a variety of programming languages. Operating system 260, typically in cooperation with processor 255, coordinates and executes functions of the other components of computer 150. Operating system 260 also provides scheduling, input-output control, file and data management, memory management, and communication control and related services, all in accordance with known techniques.

System memory 270 may be any of a variety of known or future memory storage devices. Examples include any commonly available random access memory (RAM), magnetic medium such as a resident hard disk or tape, an optical medium such as a read and write compact disc, or other memory storage device. Memory storage devices 281 may be any of a variety of known or future devices, including a compact disk drive, a tape drive, a removable hard disk drive, USB or flash drive, or a diskette drive. Such types of memory storage devices 281 typically read from, and/or write to, a program storage medium (not shown) such as, respectively, a compact disk, magnetic tape, removable hard disk, USB or flash drive, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory 270 and/or the program storage device used in conjunction with memory storage device 281.

In some embodiments, a computer program product is described comprising a computer usable medium having control logic (computer software program, including program code) stored therein. The control logic, when executed by processor 255, causes processor 255 to perform functions described herein. In other embodiments, some functions are implemented primarily in hardware using, for example, a hardware state machine. Implementation of the hardware state machine so as to perform the functions described herein will be apparent to those skilled in the relevant arts.

Input-output controllers 275 could include any of a variety of known devices for accepting and processing information from a user, whether a human or a machine, whether local or remote. Such devices include, for example, modem cards, wireless cards, network interface cards, sound cards, or other types of controllers for any of a variety of known input devices. Output controllers of input-output controllers 275 could include controllers for any of a variety of known display devices for presenting information to a user, whether a human or a machine, whether local or remote. In the illustrated embodiment, the functional elements of computer 150 communicate with each other via system bus 290. Some of these communications may be accomplished in alternative embodiments using network or other types of remote communications.

As will be evident to those skilled in the relevant art, an instrument control and image processing application, such as for instance an implementation of instrument control and image processing applications 372 illustrated in FIG. 3, if implemented in software, may be loaded into and executed from system memory 270 and/or memory storage device 281. All or portions of the instrument control and image processing applications may also reside in a read-only memory or similar device of memory storage device 281, such devices not requiring that the instrument control and image processing applications first be loaded through input-output controllers 275. It will be understood by those skilled in the relevant art that the instrument control and image processing applications 372, or portions of it, may be loaded by processor 255 in a known manner into system memory 270, or cache memory (not shown), or both, as advantageous for execution. Also illustrated in FIG. 2 are library files 274, experiment data 277, and internet client 279 stored in system memory 270. For example, experiment data 277 could include data related to one or more experiments or assays such as excitation wavelength ranges, emission wavelength ranges, extinction coefficients and/or associated excitation power level values, or other values associated with one or more fluorescent labels. Additionally, internet client 279 may include an application enabled to accesses a remote service on another computer using a network that may for instance comprise what are generally referred to as “Web Browsers”. In the present example some commonly employed web browsers include Netscape® 8.0 available from Netscape Communications Corp., Microsoft® Internet Explorer 6 with SP1 available from Microsoft Corporation, Mozilla Firefox® 1.5 from the Mozilla Corporation, Safari 2.0 from Apple Computer Corp., or other type of web browser currently known in the art or to be developed in the future. Also, in the same or other embodiments internet client 279 may include, or could be an element of, specialized software applications enabled to access remote information via a network such as network 125 such as, for instance, the GeneChip® package or Chromosome Copy Number Tool (CNAT) both available from Affymetrix, Inc. of Santa Clara Calif. that are each enabled to access information from remote sources, and in particular probe array annotation information from the NetAffx™ web site hosted on one or more servers provided by Affymetrix, Inc.

Network 125 may include one or more of the many various types of networks well known to those of ordinary skill in the art. For example, network 125 may include a local or wide area network that employs what is commonly referred to as a TCP/IP protocol suite to communicate. Network 125 may include a network comprising a worldwide system of interconnected computer networks that is commonly referred to as the internet, or could also include various intranet architectures. Those of ordinary skill in the related arts will also appreciate that some users in networked environments may prefer to employ what are generally referred to as “firewalls” (also sometimes referred to as Packet Filters, or Border Protection Devices) to control information traffic to and from hardware and/or software systems. For example, firewalls may comprise hardware or software elements or some combination thereof and are typically designed to enforce security policies put in place by users, such as for instance network administrators, etc.

Server 120: FIG. 1 shows a typical configuration of a server computer connected to a workstation computer via a network that is illustrated in further detail in FIG. 3. In some implementations any function ascribed to server 120 may be carried out by one or more other computers, and/or the functions may be performed in parallel by a group of computers.

Typically, server 120 is a network-server class of computer designed for servicing a number of workstations or other computer platforms over a network. However, server 120 may be any of a variety of types of general-purpose computers such as a personal computer, workstation, main frame computer, or other computer platform now or later developed. Server 120 typically includes known components such as processor 355, operating system 360, system memory 370, memory storage devices 381, and input-output controllers 375. It will be understood by those skilled in the relevant art that there are many possible configurations of the components of server 120 that may typically include cache memory, a data backup unit, and many other devices. Similarly, many hardware and associated software or firmware components may be implemented in a network server. For example, components to implement one or more firewalls to protect data and applications, uninterruptible power supplies, LAN switches, web-server routing software, and many other components. Those of ordinary skill in the art will readily appreciate how these and other conventional components may be implemented.

Processor 355 may include multiple processors; e.g., multiple Intel® Xeon™ 3.2 GHz processors. As further examples, the processor may include one or more of a variety of other commercially available processors such as Itanium® 2 64-bit processors or Pentium® processors from Intel, SPARC®processors made by Sun Microsystems, Opteron™ processors from Advanced Micro Devices, or other processors that are or will become available. Processor 355 executes operating system 360, which may be, for example, a Windows®-type operating system (such as Windows® XP Professional (which may include a version of Internet Information Server (IIS))) from the Microsoft Corporation; the Mac OS X Server operating system from Apple Computer Corp.; the Solaris operating system from Sun Microsystems; the Tru64 Unix from Compaq; other Unix® or Linux-type operating systems available from many vendors or open sources; another or a future operating system; or some combination thereof. Some embodiments of processor 355 may also include what are referred to as Multi-core processors and/or be enabled to employ parallel processing technology in a single or multi-core configuration similar to that as described above with respect to processor 255. In addition, those of ordinary skill in the related will appreciate that processor 355 may be configured in what is generally referred to as 32 or 64 bit architectures, or other architectural configurations now known or that may be developed in the future.

Operating system 360 interfaces with firmware and hardware in a well-known manner, and facilitates processor 355 in coordinating and executing the functions of various computer programs that may be written in a variety of programming languages. Operating system 360, typically in cooperation with the processor, coordinates and executes functions of the other components of server 120. Operating system 360 also provides scheduling, input-output control, file and data management, memory management, and communication control and related services, all in accordance with known techniques.

System memory 370 may be any of a variety of known or future memory storage devices. Examples include any commonly available random access memory (RAM), magnetic medium such as a resident hard disk or tape, an optical medium such as a read and write compact disc, or other memory storage device. Memory storage device 381 may be any of a variety of known or future devices, including a compact disk drive, a tape drive, a removable hard disk drive, USB or flash drive, or a diskette drive. Such types of memory storage device typically read from, and/or write to, a program storage medium (not shown) such as, respectively, a compact disk, magnetic tape, removable hard disk, USB or flash drive, or floppy diskette. Any of these program storage media, or others now in use or that may later be developed, may be considered a computer program product. As will be appreciated, these program storage media typically store a computer software program and/or data. Computer software programs, also called computer control logic, typically are stored in the system memory and/or the program storage device used in conjunction with the memory storage device.

In some embodiments, a computer program product is described comprising a computer usable medium having control logic (computer software program, including program code) stored therein. The control logic, when executed by the processor, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Input-output controllers 375 could include any of a variety of known devices for accepting and processing information from a user, whether a human or a machine, whether local or remote. Such devices include, for example, modem cards, network interface cards, sound cards, or other types of controllers for any of a variety of known input or output devices. In the illustrated embodiment, the functional elements of server 120 communicate with each other via system bus 390. Some of these communications may be accomplished in alternative embodiments using network or other types of remote communications.

As will be evident to those skilled in the relevant art, a server application if implemented in software may be loaded into the system memory and/or the memory storage device through one of the input devices, such as instrument control and image processing applications 372 described in greater detail below. All or portions of these loaded elements may also reside in a read-only memory or similar device of the memory storage device, such devices not requiring that the elements first be loaded through the input devices. It will be understood by those skilled in the relevant art that any of the loaded elements, or portions of them, may be loaded by the processor in a known manner into the system memory, or cache memory (not shown), or both, as advantageous for execution.

Instrument control and image processing applications 372: Instrument control and image processing applications 372 may comprise any of a variety of known or future image processing applications. Some examples of known instrument control and image processing applications include the Affymetrix® Microarray Suite, and Affymetrix® GeneChip® referred to as GCOS) applications. Typically, embodiments of applications 372 may be loaded into system memory 370 and/or memory storage device 381. For example, FIG. 3 provides an example of applications 372 stored for execution in system memory 370 illustrated as instrument control and image processing applications executables 372A. Also, those of ordinary skill in the related art will appreciate that applications 372 may be stored for execution on any compatible computer system, such as computer 150. For example, the described embodiments of applications 372 may, for example, include the Affymetrix® Command-Console™ software application.

Embodiments of applications 372 may provide what is referred to as a modular interface for one or more computers or workstations and one or more servers, as well as one or more instruments. The term “modular” as used herein generally refers to elements that may be integrated to and interact with a core element in order to provide a flexible, updateable, and customizable platform. For example, as will be described in greater detail below applications 372 may include a “core” software element enabled to communicate and perform primary functions necessary for any instrument control and image processing application. Such primary functionality may include communication over various network architectures, or data processing functions such as processing raw intensity data into a .dat file. In the present example, modular software elements, such as for instance what may be referred to as a plug-in module, may be interfaced with the core software element to perform more specific or secondary functions, such as for instance functions that are specific to particular instruments. In particular, the specific or secondary functions may include functions customizable for particular applications desired by user 101. Further, integrated modules and the core software element are considered to be a single software application, and referred to as applications 372.

In the presently described implementation, applications 372 may communicate with, and receive instruction or information from, or control one or more elements or processes of one or more servers, one or more workstations, and one or more instruments. Also, embodiments of server 120 or computer 150 with an implementation of applications 372 stored thereon could be located locally or remotely and communicate with one or more additional servers and/or one or more other computers/workstations or instruments.

In some embodiments, applications 372 may be capable of data encryption/decryption functionality. For example, it may be desirable to encrypt data, files, information associated with GUI's 246, or other information that may be transferred over network 125 to one or more remote computers or servers for data security and confidentiality purposes. For example, some embodiments of probe array 140 may be employed for diagnostic purposes where the data may be associated with a patient and/or a diagnosis of a disease or medical condition. It is desirable in many applications to protect the data using encryption for confidentiality of patient information. In addition, one-way encryption technologies may be employed in situations where access should be limited to only selected parties such as a patient and their physician. In the present example, only the selected parties have the key to decrypt or associate the data with the patient. In some applications, the one-way encrypted data may be stored in one or more public databases or repositories where even the curator of the database or repository would be unable to associate the data with the user or otherwise decrypt the information. The described encryption functionality may also have utility in clinical trial applications where it may be desirable to isolate one or more data elements from each other for the purpose of confidentiality and/or removal of experimental biases.

Various embodiments of applications 372 may provide one or more embodiments of interfaces 246 that may include interactive graphical user interfaces that allows user 101 to make selections based upon information presented in an embodiment of interface 246. Those of ordinary skill will recognize that embodiments of interface 246 may include GUI's as described above coded in various language formats such as an HTML, XHTML, XML, javascript, Jscript, or other language known to those of ordinary skill in the art used for the creation or enhancement of “Web Pages” viewable and compatible with internet client 279 or 379. For example, internet client 279 or 379 may include various internet browsers such as Microsoft Internet Explorer, Netscape Navigator, Mozilla Firefox, Apple Safari, or other browsers known in the art. Applications of GUI's viewable via one or more browsers may allow user 101 complete remote access to data, management, and registration functions without any other specialized software elements. Applications 372 may provide one or more implementations of interactive GUI's that allow user 101 to select from a variety of options including data selection, experiment parameters, calibration values, and probe array information within the access to data, management, and registration functions.

In some embodiments, applications 372 may be capable of running on operating systems in a non-English format, where applications 372 can accept input from user 101 via interface 246 in various non-English language formats such as Chinese, French, Spanish etc., and output information to user 101 in the same or other desired language output. For example, applications 372 may present information to user 101 in various implementations of a GUI in a language output desired by user 101, and similarly receive input from user 101 in the desired language. In the present example, applications 372 is internationalized such that it is capable of interpreting the input from user 101 in the desired language where the input is acceptable input with respect to the functions and capabilities of applications 372.

Embodiments of applications 372 also include instrument control features, where the control functions of individual types or specific instruments such as scanner 100, an autoloader, or a fluid processing system may be organized as plug-in type modules 373 to applications 372. For example, each plug-in module 373 may be a separate component and may provide definition of the instrument control features to applications 372. As described above, each plug-in module 373 is functionally integrated with applications 372 when stored in system memory 270 and thus reference to applications 372 includes any embodiments of integrated plug-in modules 373. In the present example, each instrument may have one or more associated embodiments of plug-in module 373 that for instance may be specific to model of instrument, revision of instrument firmware or scripts, number and/or configuration of instrument embodiment, etc. Further, multiple embodiments of plug-in module 373 for the same instrument such as scanner 100 may be stored in system memory 270 for use by applications 372, where user 101 may select the desired embodiment of module to employ, or alternatively such a selection of module may be defined by data encoded directly in a machine readable identifier or indirectly via the array file, library files, experiments files and so on.

The instrument control features may include the control of one or more elements of one or more instruments that could, for instance, include elements of a hybridization device, a fluid processing instrument, an autoloader, or scanner 100. The instrument control features may also be capable of receiving information from the one or more instruments that could include experiment or instrument status, process steps, or other relevant information. The instrument control features could, for example, be under the control of or an element of the interface of applications 372. In some embodiments, a user may input desired control commands and/or receive the instrument control information via one of interfaces 246. Additional examples of instrument control via a GUI or other interface is provided in U.S. patent application Ser. No. 10/764,663, titled “System, Method and Computer Software Product for Instrument Control, Data Acquisition, Analysis, Management and Storage”, filed Jan. 26, 2004, which is hereby incorporated by reference herein in its entirety for all purposes.

In some embodiments, applications 372 may employ what may referred to as an “array file” that comprises data employed for various instruments, processing functions of images by applications 372, or other relevant information. Generally it is desirable to consolidate elements of data or metadata related to an embodiment of probe array 140, experiment, user, or some combination thereof, to a single file that is not duplicated (i.e. as embodiments of .dat file may be in certain applications), where duplication may sometimes be a source of error. The term “metadata” as used herein generally refers to data about data. It may also be desirable in some embodiments to restrict or prohibit the ability to overwrite data in the array file. Preferentially, new information may be appended to the array file rather than deleting or overwriting information, providing the benefit of traceability and data integrity (i.e. as may be required by some regulatory agencies). For example, an array file may be associated with one or more implementations of an embodiment of probe array 140, where the array file acts to unify data across a set of probe arrays 140. The array file may be created by applications 372 via a registration process, where user 101 inputs data into applications 372 via one or more of interfaces 246. In the present example, the array file may be associated by user 101 with a custom identifier that could include a machine readable identifier such as the machine readable identifiers described in greater detail below.

Alternatively, applications 372 may create an array file and automatically associate the array file with a machine readable identifier that identifies an embodiment of probe array 140 (i.e. relationship between the machine readable identifier and probe array 140 may be assigned by a manufacturer). Applications 372 may employ various data elements for the creation or update of the array file from one or more library files, such as library files 274 or other library files.

Also in the same or alternative embodiments, the array file may include pointers to one or more additional data files comprising data related to an associated embodiment of probe array 140. For example, the manufacturer of probe array 140 or other user may provide library files 274 or other files that define characteristics such as probe identity; dimension and positional location (i.e. with respect to some fiducial reference or coordinate system) of the active area of probe array 140; various experimental parameters; instrument control parameters; or other types of useful information. In addition, the array file may also contain one or more metadata elements that could include one or more of a unique identifier for the array file, human readable form of a machine readable identifier, or other metadata elements. In addition, applications 372 may store data (i.e. as metadata, or stored data) that includes sample identifiers, array names, user parameters, event logs that may for instance include a value identifying the number of times an array has been scanned, relationship histories such as for instance the relationship between each .cel file and the one or more .dat files that were employed to generate the .cel file, and other types of data useful in for processing and data management.

For example, user 101 and/or automated data input devices or programs (not shown) may provide data related to the design or conduct of experiments. User 101 may specify an Affymetrix catalogue or custom chip type (e.g., Human Genome U133 plus 2.0 chip) either by selecting from a predetermined list presented in one or more of interfaces 246 or by scanning a bar code, Radio Frequency Identification (RFID), magnetic strip, or other means of electronic identification related to probe array 140 to read its type, part no., array identifier, etc. Applications 372 may associate the chip type, part no., array identifier with various scanning parameters stored in data tables or library files, such as library files 274 of computer 150, including the area of probe array 140 that is to be scanned, the location of chrome elements or other features on probe array 140 used for auto-focusing, the wavelength or intensity/power of excitation light to be used in reading the chip, and so on. Also, some embodiments of applications 372 may encode array files in a binary type format that may minimize the possibility of data corruption. However, applications 372 may be further enabled to export an array file in a number of different formats.

Also continuing the example above, some embodiments of RFID tags associated with embodiments of probe array 140 may be capable of “data logging” functionality where, for instance, each RFID tag or label may actively measure and record parameters of interest. In the present example, such parameters of interest may include environmental conditions such as temperature and/or humidity that the implementation of probe array 140 may have been exposed to. In the present example, user 101 may be interested in the environmental conditions because the biological integrity of some embodiments of probe array 140 may be affected by exposure to fluctuations of the environment. In some embodiments, applications 372 may extract the recorded environmental information from the RFID tag or label and store it in the array file, or some other file that has a pointer to or from the array file. In the same or alternative embodiments, applications 372 may monitor the environmental conditions exposed to the probe array in real time, where applications 372 may regularly monitor information provided by one or more RFID tags simultaneously. Applications 372 may further analyze and employ such information for quality control purposes, for data normalization, or other purposes known in the related art. Some examples of RFID embodiments capable to recording environmental parameters include the ThermAssureRF™ RFID sensor available from Evidencia LLP of Memphis Tennessee, or the Tempsens™ RFID datalogging label available from Exago Pty Ltd. of Australia.

Also, in the same or alternative embodiments, applications 372 may generate or access what may be referred to as a “plate” file. The plate file may encode one or more data elements such as pointers to one or more array files, and preferably may include pointers to a plurality of array files.

In some embodiments, raw image data is acquired from scanner 100 and operated upon by applications 372 to generate intermediate results. For example, raw intensity data acquired from scanner 100 may be directed to a .dat file generator and written to data files (*.dat) that comprise an intensity value for each pixel of data acquired from a scan of an embodiment of probe array 140. In the same or alternative embodiments it may be advantageous to scan sub areas (that may be referred to as sub arrays) of probe array 140 where the detected signal for each sub area scanned may be written to an individual embodiment of a .dat file. Continuing with the present example, applications 372 may also encode a unique identifier for each .dat file as well as a pointer to an associated embodiment of an array file as metadata into each .dat file generated. The term “pointer” as used herein generally refers to a programming language data type, variable, or data object that references another data object, datatype, variable, etc. using a memory address or identifier of the referenced element in a memory storage device such as in system memory 270. In some embodiments the pointers comprise the unique identifiers of the files that are the subject of the pointing, such as for instance the pointer in a .dat file comprises the unique identifier of the array file. Additional examples of the generation and image processing of sub arrays is described in U.S. patent application Ser. No. 11/289,975, titled “System, Method, and Product for Analyzing Images Comprising Small Feature Sizes”, filed Nov. 30, 2005, which is hereby incorporated by reference herein in its entirety for all purpose.

Also, applications 372 may also include a .cel file generator that may produce one or more .cel files (*.cel) by processing each .dat file. Alternatively, some embodiments of .cel file generator may produce a single .cel file from processing multiple .dat files such as with the example of processing multiple sub-arrays described above. Similar to the .dat file described above each embodiment of .cel file may also include one or more metadata elements. For example, applications 372 may encode a unique identifier for each .cel file as well as a pointer to an associated array file and/or the one or more .dat files used to produce the .cel file.

Each .cel file contains, for each probe feature scanned by scanner 100, a single value representative of the intensities of pixels measured by scanner 100 for that probe feature. For example, this value may include a measure of the abundance of tagged mRNA's present in the sample that hybridized to the corresponding probe molecules disposed in the probe feature. Many such mRNA's may be present in each probe feature, as a probe feature on a GeneChip® probe array may include, for example, millions of oligonucleotides designed to detect the mRNA's. Alternatively, the value may include a measure related to the sequence composition of DNA or other nucleic acid detected by the probes disposed in probe features of a GeneChip® probe array.

As described above, applications 372 receives image data derived from probe array 140 using scanner 100 and generates a .dat file that is then processed by applications 372 to produce a .cel intensity file, where applications 372 may utilize information from an array file in the image processing function. For instance, a .cel file generator may perform what is referred to as grid placement methods on the image data in each .dat file using data elements such as dimension information to determine and define the positional location of probe features in the image. Typically, the .cel file generator associates what may be referred to as a grid with the image data in a .dat file for the purpose of determining the positional relationship of probe features in the image with the known positions and identities of the probe features. The accurate registration of the grid with the image is important for the accuracy of the information in the resulting .cel file. Also, some embodiments of .cel file generator may provide user 101 with a graphical representation of a grid aligned to image data from a selected .dat file in an implementation of interface 246 comprising a GUI, and further enable user 101 to manually refine the position of the grid placement using methods commonly employed such as placing a cursor over the grid, selecting such as by holding down a button on a mouse, and dragging the grid to a preferred positional relationship with the image. Applications 372 may then perform methods sometimes referred to as “feature extraction” to assign a value of intensity for each probe represented in the image as an area defined by the boundary lines of the grid. Examples of grid registration, methods of positional refinement, and feature extraction are described in U.S. Pat. Nos. 6,090,555; 6,611,767; 6,829,376, and U.S. patent application Ser. Nos. 10/391,882, and 10/197,369, each of which is hereby incorporated by reference herein in its entirety for all purposes.

As noted, another file that may be generated by applications 372 is a .chp file using a .chp file generator. For example, each .chp file is derived from analysis of a .cel file combined in some cases with information derived from an array file, other lab data and/or library files 274 that specify details regarding the sequences and locations of probes and controls. In some embodiments, a machine readable identifier associated with probe array 140 may indicate the library file directly or indirectly via one or more identifiers in the array file, to employ for identification of the probes and their positional locations. The resulting data stored in the .chp file includes degrees of hybridization, absolute and/or differential (over two or more experiments) expression, genotype comparisons, detection of polymorphisms and mutations, and other analytical results.

In some alternative embodiments, user 101 may prefer to employ different applications to process data such as an independent analysis application. An embodiment of an analysis application is illustrated in FIG. 3 as analysis application 380, and also illustrated as stored for execution in system memory 370 as analysis application executables 380A. Embodiments of analysis application 380 may comprise any of a variety of known or probe array analysis applications, and particularly analysis applications specialized for use with particular embodiments of probe array 140 such as those designed for certain genotyping or expression applications. For example, one such embodiment of analysis application 380 may include elements that are specialized for analysis of data from embodiments of probe array 140 comprising probes that interrogate exon regions.

Various embodiments of analysis application 380 may exist such as applications developed by a probe array manufacturer for specialized embodiments of probe array 140, commercial third party software applications, open source applications, or other applications known in the art for specific analysis of data from probe arrays 140. Some examples of known genotyping analysis applications include the Affymetrix® GeneChip® Data Analysis System (GDAS), Affymetrix® GeneChip® Genotyping Analysis Software (GTYPE), Affymetrix® GeneChip® Targeted Genotyping Analysis Software (GTGS), and Affymetrix® GeneChip® Sequence Analysis Software (GSEQ) applications. Additional examples of genotyping analysis applications may be found in U.S. patent application Ser. Nos. 10/657,481; 10/986,963; and 11/157,768; each of which is hereby incorporated by reference herein in it's entirety for all purposes. Typically, embodiments of analysis applications may be loaded into system memory 370 and/or memory storage device 381.

As described above, some embodiments of analysis applications 380 include executable code being stored in system memory 370. Applications 372 may be enabled to export .cel files, .dat files, or other files to an analysis application or enable access to such files on computer 150 by the analysis application. Import and/or export functionality for compatibility with specific systems or applications may be enabled by one or more integrated modules as described above with respect to plug-in modules. For example, an analysis application may be capable of performing specialized analysis of processed intensity data, such as the data in a .cel file. In the present example, user 101 may desire to process data associated with a plurality of implementations of probe array 140 and therefore the analysis application would receive a .cel file associated with each probe array for processing. In the present example, applications 372 forwards the appropriate files in response to queries or requests from the analysis application.

In the same or alternative examples, user 101 and/or the third party developers may employ what are referred to as software development kits that enable programmatic access into file formats, or the structure of applications 372. Therefore, developers of other software applications such as the described analysis application may integrate with and seamlessly add functionally to or utilize data from applications 372 that provides user 101 with a wide range of application and processing capability. Additional examples of software development kits associated with software or data related to probe arrays are described in U.S. Pat. No. 6,954,699, and U.S. application Ser. Nos. 10/764,663 and 11/215,900, each of which is hereby incorporated by reference herein in its entirety for all purposes.

Additional examples of .cel and .chp files are described with respect to the Affymetrix GeneChip® Operating Software or Affymetrix® Microarray Suite (as described, for example, in U.S. patent application, Ser. Nos. 10/219,882, and 10/764,663, both of which are hereby incorporated herein by reference in their entireties for all purposes). For convenience, the term “file” often is used herein to refer to data generated or used by applications 372 and executable counterparts of other applications such as analysis application 380, where the data is written according a format such as the described .dat, cel, and .chp formats. Further, the data files may also be used as input for applications 372 or other software capable of reading the format of the file.

Those of ordinary skill in the related art will appreciate that one or more operations of applications 372 may be performed by software or firmware associated with various instruments. For example, scanner 100 could include a computer that may include a firmware component that performs or controls one or more operations associated with scanner 100.

Yet another example of instrument control and image processing applications is described in U.S. patent application Ser. No. 11/279,068, titled “System, Method and Computer Product for Simplified Instrument Control and File Management”, filed Apr. 7, 2006, which is hereby incorporated by reference herein in its entirety for all purposes.

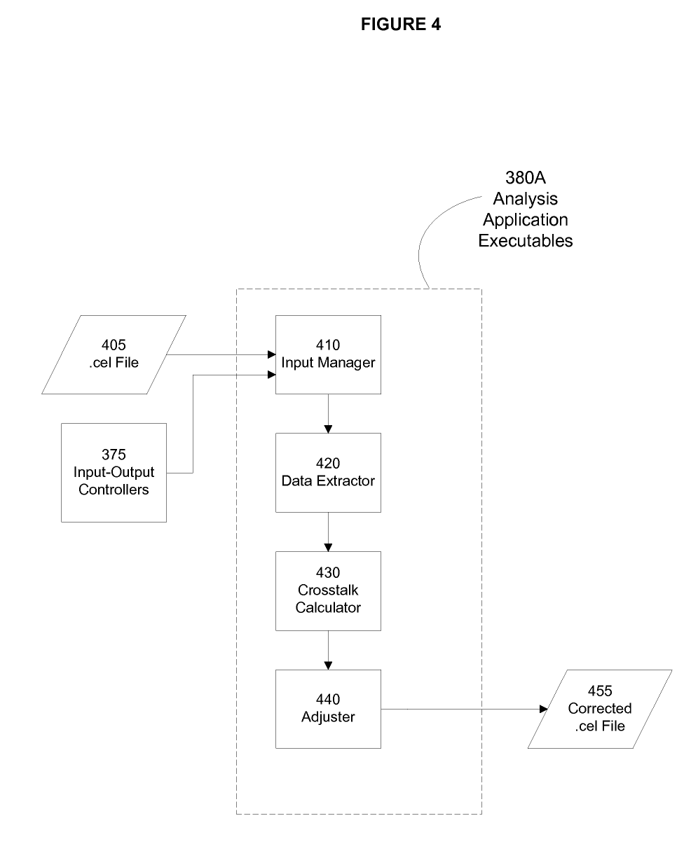

Analysis Application 380: An illustrative example of analysis application 380 is provided in FIG. 3, and in greater detail in FIG. 4. Some embodiments of analysis application 380 may serve as a stand-alone application for processing intermediate results. Alternatively, embodiments of analysis application 380 could be a component of or integrated to work cooperatively with applications 372. For example, application 380 may be specialized to process data associated with one or more .cel files generated by instrument control and image processing applications 372 as described above.

The embodiments of applications 380 as described herein perform one or more methods for determining and correcting for feature leakage, also referred to as feature “crosstalk” that may exist in data generated by scanning probe arrays 140 using scanner 100. In general, feature crosstalk is produced when scanner 100 introduces blurriness when acquiring data from probe array 140. For example, optical instruments do not have infinitely high spatial resolution. The image of an infinitesimally small point is not infinitesimally small. Image blur caused by diffraction is always present. Image blur can also be caused by what is referred to as spherical aberration, coma, defocus, vibration, turbulence in the air or liquid between the imaged object and the lens element, etc. Image blur can be characterized by what is referred to as a point spread function (described in Modem Optical Engineering, Warren J. Smith, McGraw-Hill, 2000, which is hereby incorporated by reference herein in its entirety for all purposes). Those of ordinary skill in the related art will appreciate that image blur can have a significant effect on observed feature intensities unless the width of the point spread function is much less than the size of features in the image.

Some embodiments of application 380 or other application may be enabled to determine a value for a point spread function of scanner 100. For example, the point spread function of the instrument can be calculated if an accurate optical model of the instrument is available. Alternatively, the point spread function of the instrument can be measured, for instance by taking images of 175-nanometer-diameter fluorescent beads (for instance the PS-Speck™ Microscope Point Source Kit, Molecular Probes Inc, Eugene Oreg.). As another alternative, the edge spread function of the instrument can be measured (for example, by taking images of a chrome-on-glass knife edge), and the point spread function can be calculated by an appropriate mathematical transformation of the edge spread function. In the presently described example, when the point spread function of the instrument is accurately known, a crosstalk parameter for a pair of features having known sizes and locations can be calculated by numerical integration.

In addition, those of ordinary skill in the related art will appreciate that it is possible to deconvolve image data at the .dat file (i.e. data comprising an intensity value for every pixel) level to remove the blurring effects introduced by scanner 100. For example, images in digital form can be de-blurred mathematically by methods that include what are referred to as Van Cittert deconvolution, Richardson-Lucy deconvolution, or other deconvolution methods. These methods of deconvolution, when used at the pixel (.dat file) level, can require a large amount of computer time to process, particularly when images are large. An image of probe array 140, for instance, can contain more than 100 million pixels. Iterative deconvolution (such as, Van Cittert deconvolution) at the pixel level can require tens or hundreds of cycles of iteration to give satisfactory results. In addition, these methods often introduce image artifacts referred to as overshoot and ringing unless the point spread function is very accurately known. Additional examples of image deconvolution at the pixel (.dat file) level are described in U.S. patent application Ser. No. 11/289,975, titled “System, Method, and Product for Analyzing Images Comprising Small Feature Sizes”, filed Nov. 30, 2005, which is hereby incorporated by reference herein in its entirety for all purposes.

Embodiments of the presently described invention include a more efficient means for determining and correcting feature crosstalk associated with the point spread function. Also, the presently described invention does not require an a priori knowledge of the point spread function or other specific optical characteristics. Instead, the invention analyzes data at the .cel file (i.e. data comprising an intensity value for every probe feature processed from the .dat file level) level where the feature crosstalk can be easily measured and corrected in a computationally efficient way. For example, the described method of crosstalk removal is computationally efficient because the number of probe features in an image is typically less than 1/25 the number of pixels in the same image. Furthermore, iterative crosstalk removal at the .cel file level usually requires fewer than ten iterations, and in many cases requires only a single iteration to produce substantial improvements in data quality.

The result of the invention is a corrected .cel file that contains intensity values that are more accurate than the intensity values in the original .cel file because the effects of crosstalk on intensities have been removed. This is because the intensity values in an image generated using the corrected .cel file are more representative of intensity values of a true image of probe array 140 (i.e. with the blurring removed). The results of the invention may also provide user 101 with additional utility. For example, a measure of crosstalk determined by application 380 may be employed as an indicator of the quality or state of calibration of scanner 100. For instance if the measure of crosstalk is very large it may indicate that scanner 100 requires service. Since each image generated by scanner 100 may be analyzed it allows user 101 to identify issues at a very early stage. This could save user 101 time and resources lost to the use of a defective instrument. Additionally, the present method provides a metric that could be useful for testing scanner design.

An example of crosstalk between adjacent features at the .cel file level is illustrated in tables 1 and 2 below. The measure of crosstalk can be characterized by a crosstalk parameter c. In the present example, consider a 3×3 array of features having true intensities as shown in table 1.

TABLE 1

| | | |
|---|---|---|
| 0 | 0 | 0 |
| 0 | 1000 | 0 |
| 0 | 0 | 0 |

Table 2 provides an illustrative example of the effect of crosstalk on the intensity values of neighboring features using a representative crosstalk parameter of 0.03. For instance, table 2 illustrates the observed feature intensities for the same 3×3 array of features as shown in table 1:

TABLE 2

| | | |
|---|---|---|
| 0 | 30 | 0 |
| 30 | 880 | 30 |
| 0 | 30 | 0 |

In some embodiments, observed feature intensities in a .cel file may be represented by equation 1, in which O(i,j) is the observed intensity of the probe feature in row i and column j. T(i,j) is the true intensity of the same probe feature in row i and column j.
O(i,j)=(1−4c)T(i,j)+c[T(i,j+1)+T(i,j−1)+T(i+1,j)+T(i−1,j)] equation 1

Solving equation 1 for T(i,j) yields equation 2.
T(i,j)={O(i,j)−c[T(i,j+1)+T(i,j−1)+T(i+1,j)+T(i−1,j)]}/(1−4c) equation 2

Using equation 2 it is not possible to find the true intensity of a feature without first knowing the true intensities of its neighbors. However, if c is small it is reasonable to approximate T(i,j+1) by O(i,j+1) and T(i,j−1) by O(i,j−1), etc, giving equation 3.
C(i,j)={O(i,j)−c[O(i,j+1)+O(i,j−1)+O(i+1,j)+O(i−1,j)]}/(1−4c) equation 3

In equation 3, C(i,j) is the corrected probe feature intensity in row i and column j, which is substantially equal to the true feature intensity T(i,j). The factor of 1/(1−4c) in equation 3 is a normalization factor, which ensures that the sum of corrected intensities is equal to the sum of observed intensities. Frequently, relative intensities are important but absolute intensities are not. Under these circumstances, the factor of 1/(1−4c) in equation 3 can be omitted, giving equation 4.
C(i,j)=O(i,j)−c[O(i,j+1)+O(i,j−1)+O(i+1,j)+O(i−1,j)] equation 4

Using equation 3 or equation 4, application 380 can calculate the corrected intensity of each feature if the crosstalk parameter c and the observed intensities of the features are known.

In the same or alternative embodiments, application 380 may employ another method of crosstalk reduction. For example, the array of observed feature intensities, represented as O, is known, but the array of true feature intensities, represented as T, is not known. The goal of this method is to find an array of corrected feature intensities, represented as C that is a good approximation to the array of true feature intensities, T. In the present example, application 380 calculates feature intensities for array B by adding crosstalk to the feature intensities of array C. If the crosstalk parameter c is known, array C is substantially the same as array T (i.e. True intensity values) when array B is substantially the same as array O (i.e. Observed intensity values). The intensity values for arrays B and C are found iteratively using equations 6, 7, and 8.
C⁽¹⁾(i,j)=O(i,j) equation 6
B⁽ⁿ⁾(i,j)=(1−4c)C⁽ⁿ⁾(i,j)+c[C⁽ⁿ⁾(i,j+1)+C⁽ⁿ⁾(i,j−1)+C⁽ⁿ⁾(i+1j)+C⁽ⁿ⁾(i−1j)] equation 7
C⁽ⁿ⁺¹⁾(i,j)=C⁽ⁿ⁾(i,j)+O(i,j)−B⁽ⁿ⁾(i,j) equation 8

In the present example, if the crosstalk parameter c is accurately known, the corrected feature intensities C(i,j) become equal to the true feature intensities T(i,j) after a sufficient number of iterations. In some embodiments, a “sufficient number of iterations” may be reached when convergence is achieved or a measure of difference between iterations is below a threshold value that may be predetermined or user selected. Those of ordinary skill in the related art will understand that the described method, when performed at the pixel (.dat file) level rather than at the feature (.cel file) level, is referred to as Van Cittert deconvolution.

In certain embodiments, it may be necessary or desirable for application 380 to perform only a single iteration. In the case of the described embodiment, equations 6, 7, and 8 can be combined to yield equation 9.
C(i,j)=(1+4c)O(i,j)−c[O(i,j+1)+O(i,j−1)+O(i+1,j)+O(i−1,j)] equation 9

Those of ordinary skill in the related art will appreciate that equation 9, when used at the pixel (.dat file) level rather than at the feature (.cel file) level, is similar to a method commonly referred to as unsharp masking.

Some embodiments of applications 380 or other application may be enabled to calculate or approximate the crosstalk parameter used in the equations described above. For example, applications 380 may calculate the crosstalk parameter using a test area having an isolated bright feature that may be referred to as the test feature.

In the present example, the test feature may be located in the middle of a block of 25 (5×5) features that are known to have true intensities of zero. In the present example, if the bright feature has an observed intensity of b and each of the four nearest-neighbor features has an observed intensities of d, the crosstalk parameter c is given by the equation c=d/(b+4d).

Further, some embodiments of application 380 may calculate the crosstalk parameter value assuming a linear relationship exists between intensity contributed by a bright feature to the selected neighbors. For instance, application 380 may employ a graph where the Y-axis represents the bright feature intensity, and the X-axis represents neighbor feature intensity. Application 380 plots a data point for each bright feature/neighbor pair, or alternatively, in some embodiments application 380 may use an average value of all selected neighbors and plot a data point for each test/average neighbor value pair. Application 380 may use linear regression techniques known in the art to plot a line that best fits all points in the graph. Application 380 then determines the slope of the line and assigns the slope value as the crosstalk parameter.

In the same or alternative embodiments, application 380 may calculate the crosstalk parameter using a feature that is known to have a true intensity of zero (for example, because the feature contains no probes that hybridize to the target) that is adjacent to one or more bright features. In the described embodiment, application 380 may calculate the crosstalk parameter using equation 1. For example, in the 3×3 array shown below in table 3, if the feature with an observed intensity of 16 is known to have a true intensity of zero, equation 1 becomes 16=c(200+300+250+50), or c=0.02. When this method is used, it might be desirable to measure the crosstalk parameter for several sets of features and average the results.

TABLE 3

| | | |
|---|---|---|
| 100 | 200 | 10 |
| 300 | 16 | 250 |
| 150 | 50 | 350 |

In some embodiments, crosstalk between adjacent features may be assumed to be the same in all four directions (left, right, up, down) and the same in all regions of the image. However, in some implementations this is not necessarily true. In addition, if the optical train of scanner 100 is not fully corrected for coma, image blur in the upper left corner of the image might be primarily down and to the right, and image blur in the lower right corner of the image might be primarily up and to the left. Further, the crosstalk parameter might be a function of distance from the center of the image if the optical train of scanner 100 is not fully corrected for field curvature. In addition, autofocus errors, temperature changes, etc can cause the crosstalk parameters to be different for images of different probe arrays and for images that are taken at different times. For example, application 380 may account for regionally dependent differences in the crosstalk parameter by measuring and correcting in sub-regions as described in greater detail below.

The embodiments described above generally account for crosstalk between a feature and its four nearest neighbors. However, the described methods of crosstalk correction can be generalized to account for crosstalk between a feature and its second-nearest neighbors, third-nearest neighbors, etc. Furthermore, the features do not need to be square or rectangular. Rather probe array 140 may comprise hexagonal features each having six nearest neighbors instead of four.

Even further, in some embodiments equation 4 can be generalized to yield equation 10. Equation 10 accounts for crosstalk between every feature in probe array 140 and every other feature, whether the features are adjacent or not. In equation 10, the sum of intensity value multiplied by crosstalk parameter is taken over all values of k and m. For example, application 380 takes the sum of intensity values over all of the features of array O. In this equation the crosstalk parameter c(i,j,k,m) can be different for each pair of features. The crosstalk parameter c(i,j,k,m) is not necessarily equal to c(k,m,i,j). The other equations discussed above can be similarly generalized.
C(i,j)=O(i,j)−Σ(c(i,j,k,m)O(k,m)) equation 10

In the way of example, application 380 may determine a value for the crosstalk parameter of approximately 0.005 using images of 8-micron features obtained using an embodiment of scanner 100 that includes a 10× microscope objective having a numerical aperture of 0.4 and a 1.8 μm diameter Airy disk at a 590 nm wavelength. Continuing with the present example, application 380 may determine a value for the crosstalk parameter of approximately 0.04 using images of 1 μm features obtained using an embodiment of scanner 100 that includes a 40× microscope objective having a numerical aperture of 0.6 and a 1.2 μm diameter Airy disk at a 590 nm wavelength.

Similar to tables 1 and 2 above, tables 4-9 provide illustrative examples of how the methods of crosstalk reduction described above perform. In particular table 5 provides an illustrative example of results obtained when using the method of equation 3, and tables 6-8 provides an illustrative example of results obtained when using the method of equations 6, 7, and 8. For instance, an example of an array of true feature intensities is illustrated in table 4. For the purpose of illustration, all feature intensities are rounded to the nearest integer.

TABLE 4

| | | | | |
|---|---|---|---|---|
| 0 | 0 | 0 | 0 | 0 |
| 0 | 1000 | 10 | 10 | 0 |
| 0 | 0 | 0 | 0 | 0 |

Again, table 5 provides an illustrative example of the effect of crosstalk on the intensity values of neighboring features using a representative crosstalk parameter of 0.03. For instance, table 5 illustrates the observed feature intensities for the same array of features as shown in table 4

TABLE 5

| | | | | |
|---|---|---|---|---|
| 0 | 30 | 0 | 0 | 0 |
| 30 | 880 | 39 | 9 | 0 |
| 0 | 30 | 0 | 0 | 0 |

As described above, table 6 provides an illustrative example of corrected feature intensities derived using the method of equation 3 when applied to the array of observed feature intensity values of table 5. In the present example, corrected feature intensity values that are negative can be set to zero before the data are analyzed (i.e. a negative intensity value is not representative of a true state).

TABLE 6

| | | | | |
|---|---|---|---|---|
| −2 | 4 | −2 | 0 | 0 |
| 4 | 996 | 14 | 9 | 0 |
| −2 | 4 | −2 | 0 | 0 |

Similarly, tables 7-9 provides an illustrative example of corrected feature intensities derived using the method of equations 6, 7, and 8 when applied to the array of observed feature intensity values of table 5. Specifically, table 7 illustrates corrected feature intensities obtained after a single iteration;

TABLE 7

| | | | | |
|---|---|---|---|---|
| −2 | 7 | −2 | 0 | 0 |
| 7 | 982 | 17 | 9 | 0 |
| −2 | 7 | −2 | 0 | 0 |

Table 8 illustrates the corrected feature intensities after two iterations; and

TABLE 8

| | | | | |
|---|---|---|---|---|
| −1 | 2 | −1 | 0 | 0 |
| 2 | 997 | 12 | 10 | 0 |
| −1 | 2 | −1 | 0 | 0 |

Table 9 illustrates the corrected feature intensities after three iterations.

TABLE 9

| | | | | |
|---|---|---|---|---|
| 0 | 0 | 0 | 0 | 0 |
| 0 | 999 | 10 | 10 | 0 |
| 0 | 0 | 0 | 0 | 0 |

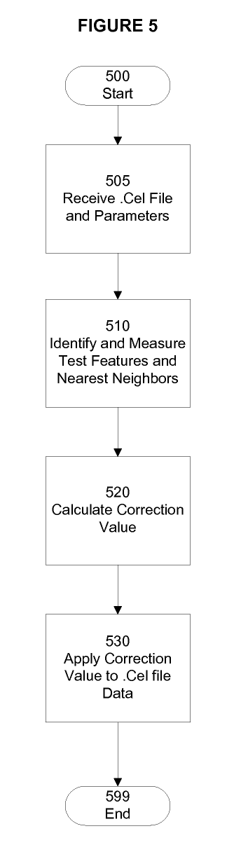

FIG. 5 provides an illustrative example of a method for measuring and correcting for crosstalk employing the illustrative elements of FIG. 4. For example, step 505 illustrates the step of input manager 410 receiving .cel file 405 that as described above has been processed from pixel data to comprise a single representative intensity value for each probe feature of probe array 140. In the present example, .cel files 405 may be associated with embodiments of probe array 140 that include very small probe features, some comprising 5 μm, 3 μm, 1 μm, or sub-micron probe feature dimensions. As those of ordinary skill in the art will appreciate, the blurring may have a more significant impact in the accuracy of intensity values represented in .cel files 405 as features dimension becomes progressively smaller.

In addition, those of ordinary skill in the related art will appreciate that accurate placement of the grid on an image generated from a .dat file has substantial impact when generating data for .cel file 405. For example, the placement of the grid on an image associated with a .dat file is used to positionally register each probe feature in the image. The .dat file image with the grid is then processed to generate a .cel file that includes a single intensity value for each of the registered features. If the grid is misaligned with the image, the features will not be registered accurately and the intensity values assigned to features in the .cel file will reflect the error of the misaligned features. In the present example, true signal of some probe features may be misinterpreted as crosstalk and therefore robust methods of grid alignment are highly desirable.

Continuing the example of step 505, input manager 410 may also receive one or more parameters from one or more library files or selections from user 101 via input-output controllers 375, system bus 390, local cache memory, or other sources described above. The parameters may include the number, identity, and/or positional locations test areas that may include one or more probe or control features. As described above the “test areas” typically include bright features that have one or more neighboring dim features adjacent to the bright feature. For example, the bright features may be part of one or more patterns of features used to a positional reference to anchor a grid to a .dat file image. In the present example, embodiments of anchor patterns may include a pattern of alternating bright and dim features in a checkerboard-like configuration. Also, the anchor patterns may be located at the corners of probe array 140 and/or regularly distributed throughout the active area. Other test areas may include various other control features distributed throughout the active area of probe array 140, particular probe features that may be known to be active in the biological context tested with probe array 140 (i.e. probe features that interrogate gene expression or genotype composition known to be present in the biological sample), etc.

As illustrated in step 510, data extractor 420 receives .cel file 405 and parameters to identify and extract the intensity values of the test features and the selected neighboring features. For example, for each identified test feature and neighbor employed in the method, determiner 420 reads the intensity value from .cel file 405. Determiner 420 may store the intensity values in a spreadsheet, cache memory, random access memory, or other storage medium known in the art.

Step 520 illustrates crosstalk calculator 430 that determines a crosstalk parameter value for .cel file 405 using the intensity values extracted by determiner 420. In some embodiments, calculator 430 may measure and independently correct for crosstalk in sub-regions of an image due to spatially or regionally dependent differences of crosstalk as described above. Thus localized crosstalk effects may be measured and accounted for more accurately. For example, those of ordinary skill in the related art will appreciate that the dimension of each sub-region may depend upon various factors such as the particular embodiment of probe array 140, experimental or optical characteristics, or other reasons. In the present example, the sub-regions may be ordered in an array of sub-regions where the number and dimension of the sub-regions may be defined in a library file or selected by user 101. Also, the sub-regions may be selected on the basis of a known or expected consistency of the crosstalk parameter associated within each region.

Alternatively, in some embodiments calculator 430 may select a constant value as a crosstalk parameter value. In certain embodiments a constant value may be reasonably employed without the computational expense of calculating the crosstalk parameter value. For example, a constant value may be useful in cases of analyzing replicate or multiple images produced within an acceptable time frame using the same embodiment of scanner 100. In such a case user 101 may assume that little change to the point spread function of scanner 100 or other substantial change has not occurred. In the present example, the constant may be an estimation of the amount of feature crosstalk been derived from previous experience. In the present example, the constant value may include a value of 0.005 for 8 μm features or 0.04 for 1 μm features.

As described in step 530, adjuster 440 applies the crosstalk parameter value to .cel file 405 or each of the sub-regions to produce corrected .cel file 455 using the equations described above. For example, adjuster 440 may handle or store .cel file 455 in any manner previously described including making .cel file 455 available for further analysis.

Having described various embodiments and implementations, it should be apparent to those skilled in the relevant art that the foregoing is illustrative only and not limiting, having been presented by way of example only. Many other schemes for distributing functions among the various functional elements of the illustrated embodiment are possible. The functions of any element may be carried out in various ways in alternative embodiments.

Also, the functions of several elements may, in alternative embodiments, be carried out by fewer, or a single, element. Similarly, in some embodiments, any functional element may perform fewer, or different, operations than those described with respect to the illustrated embodiment. Also, functional elements shown as distinct for purposes of illustration may be incorporated within other functional elements in a particular implementation. Also, the sequencing of functions or portions of functions generally may be altered. Certain functional elements, files, data structures, and so on may be described in the illustrated embodiments as located in system memory of a particular computer. In other embodiments, however, they may be located on, or distributed across, computer systems or other platforms that are co-located and/or remote from each other. For example, any one or more of data files or data structures described as co-located on and “local” to a server or other computer may be located in a computer system or systems remote from the server. In addition, it will be understood by those skilled in the relevant art that control and data flows between and among functional elements and various data structures may vary in many ways from the control and data flows described above or in documents incorporated by reference herein. More particularly, intermediary functional elements may direct control or data flows, and the functions of various elements may be combined, divided, or otherwise rearranged to allow parallel processing or for other reasons. Also, intermediate data structures or files may be used and various described data structures or files may be combined or otherwise arranged. Numerous other embodiments, and modifications thereof, are contemplated as falling within the scope of the present invention as defined by appended claims and equivalents thereto.

What is claimed is:

1. A method for correcting feature overlap in biological probe array data, comprising:
(a) receiving a first set of data comprising an intensity value for each of a plurality of features associated with a probe array;
(b) calculating a crosstalk parameter for the first set of data using the intensity values of one or more test features and a plurality of features that neighbor each test feature; and
(c) applying the crosstalk parameter to each intensity value in the first set of data to produce a second set of data.

2. The method of claim 1, wherein:
at least one of the plurality of features comprise probe features.

3. The method of claim 1, wherein:
at least one of the plurality of features comprise control features.

4. The method of claim 1, wherein:
the first set of data is generated by processing raw data from a scanned biological probe array.

5. The method of claim 4, wherein:
the first set of data is a .cel file.

6. The method of claim 1, wherein:
the crosstalk parameter represents a measure of feature leakage.

7. The method of claim 6, wherein:
feature leakage includes an intensity contribution from a first feature to one or more neighboring features.

8. The method of claim 6, wherein:
feature leakage is the result of blurring.

9. The method of claim 8, wherein:
the blurring is associated with a point spread function of an optical instrument.

10. The method of claim 8, wherein:
a source of the blurring includes one or more of the group consisting of diffraction, spherical aberration, coma, defocus, vibration, turbulence in the air or liquid between the imaged object and the lens element, and temperature differences.

11. The method of claim 1, further comprising:
applying steps (b)-(c) for a plurality of sub-sets of the set of data

12. The method of claim 11, wherein:
the sub-sets are associated with regions in an image

13. A system for correcting feature overlap in biological probe array data, comprising:
a input manager that receives a first set of data comprising an intensity value for each of a plurality of features associated with a probe array;
a calculator that calculates a crosstalk parameter for the first set of data using the intensity values of one or more test features and a plurality of features that neighbor each test feature; and
an adjuster that applies the crosstalk parameter to each intensity value in the first set of data to produce a second set of data.

14. The system of claim 13, wherein:
at least one of the plurality of features comprise probe features.

15. The system of claim 13, wherein:
at least one of the plurality of features comprise control features.

16. The system of claim 13, wherein:
the first set of data is generated by processing raw data from a scanned biological probe array.

17. The system of claim 16, wherein:
the first set of data is a .cel file.

18. The system of claim 13, wherein:
the crosstalk parameter represents a measure of feature leakage.

19. The system of claim 18, wherein:
feature leakage includes an intensity contribution from a first feature to one or more neighboring features.

20. The system of claim 18, wherein:
feature leakage is the result of blurring.

21. The system of claim 20, wherein:
the blurring is associated with a point spread function of an optical instrument.

22. The method of claim 20, wherein:
a source of the blurring includes one or more of the group consisting of diffraction, spherical aberration, coma, defocus, vibration, turbulence in the air or liquid between the imaged object and the lens element, and temperature differences.

23. The system of claim 13, wherein:
the calculator calculates a crosstalk parameter for each of a plurality of sub-sets of the set of data; and
the adjuster applies each crosstalk parameter to each intensity value in the associated sub-set.

24. The system of claim 23, wherein:
the sub-sets are associated with regions in an image

25. A system for correcting feature overlap in biological probe array data, comprising:
a scanner that acquires a first set of data from a biological probe array; and
a computer comprising executable code stored thereon, wherein the executable code performs a method of:
processing the first set of data to produce a second set of data comprising an intensity value for each of a plurality of features associated with the probe array;
calculating a crosstalk parameter for the second set of data using the intensity values of one or more test features and one or more features that neighbor each test feature; and
applying the crosstalk parameter to each intensity value in the second set of data to produce a third set of data.

26. A method for correcting feature overlap in biological probe array data, comprising:
(a) receiving a first set of data comprising an intensity value for each of a plurality of features associated with a probe array, and a crosstalk parameter for the first set of data; and
(c) applying the crosstalk parameter to each intensity value in the first set of data to produce a second set of data.

27. The method of claim 26, wherein:
the crosstalk parameter represents a measure of feature leakage.

28. The method of claim 27, wherein:
feature leakage includes an intensity contribution from a first feature to one or more neighboring features.

29. The method of claim 27, wherein:
feature leakage is the result of blurring.

30. The method of claim 29, wherein:
the blurring is associated with a point spread function of an optical instrument.

31. The method of claim 29, wherein:
a source of the blurring includes one or more of the group consisting of diffraction, spherical aberration, coma, defocus, vibration, turbulence in the air or liquid between the imaged object and the lens element, and temperature differences.

32. The method of claim 26, further comprising:
generating an image using the second set of data.

33. The method of claim 32, wherein:
the image is substantially the same as a true image of the probe array.
